(19) United States
(12) Patent Application Publication
(10) Pub. No.: US 2016/0041939 A1
(43) Pub. Date: Feb. 11, 2016

(54) SATA EXPRESS INTERFACE STORAGE DEVICE AND MOTHERBOARD INSERTEDLY PROVIDED THEREOF

(71) Applicant: Innodisk Corporation, New Taipei City (TW)

(72) Inventors: Chin-Chung KUO, NEW TAIPEI CITY (TW); Chia-Wei LI, NEW TAIPEI CITY (TW)

(21) Appl. No.: 14/807,560

(22) Filed: Jul. 23, 2015

(30) Foreign Application Priority Data
Aug. 7, 2014 (TW) 103127077

(51) Int. Cl. G06F 13/40; G06F 13/42

(52) U.S. Cl. CPC G06F 13/4068; G06F 13/4282

(57) ABSTRACT

A storage device with SATA express interface is provided. The storage device comprises a connector, a first controller unit and a second controller unit. The connector comprises a first data connecting terminal, a second data connecting terminal and a control terminal. There are two detection pins of the connector defined from pins of the control terminal The first data connecting terminal defined by the first controller unit is used for transmitting data of a first storage, and the second data connecting terminal defined by the second controller unit is used for transmitting data of a second storage. Thereby, there is able to determine that the first data connecting terminal or the second data connecting terminal for transmitting data conforming to a first transfer protocol specification or a second transfer protocol specification by detecting the two detection pins of the connector.

### CROSS-REFERENCE TO RELATED APPLICATIONS

This non-provisional application claims priority claim under 35 U.S.C. §119(a) on Taiwan Patent Application No. 103127077 filed Aug. 7, 2014, the entire contents of which are incorporated herein by reference.

### FIELD OF THE INVENTION

The present invention is related to a storage device and motherboard insertedly provided thereof, particularly to a storage device, having a connector conforming to SATA Express interface specification, and a motherboard insertedly provided thereof

### BACKGROUND

The performance of solid-state drives (SSD) continues to improve, so that currently SATA bandwidth transfer speed has been inadequate for demand, for example, the bandwidth transfer speed of SATA 3 is 6 Gb/s. To improve SATA bandwidth transfer speed, SATA-IO association, based on PCI-Express interface, to develop novel SATA Express interface specification, the bandwidth transfer speed of which can reach 8 Gb/s or 16 Gb/s.

The SATA Express interface specification is able to allow the SATA Express interface configured with one or two storages that can be SSD or flash memory module. For the pin definition of the SATA Express interface as described in table 1.

TABLE 1

| Pin NO. | Description of Pin | Pin NO. | Description of Pin |
|---|---|---|---|
| S1 | GND | S10 | A1− |
| S2 | A0+ | S11 | GND |
| S3 | A0− | S12 | B1+ |
| S4 | GND | S13 | B1− |
| S5 | B0+ | S14 | GND |
| S6 | B0− | P1 | Reserved |
| S7 | GND | P2 | PERST# |
| S8 | GND | P3 | CLKREQ#/DEVSLP |
| S9 | A1+ | P4 | DET |

S1˜S7 pins are employed by the first storage, and S2, S3, S5, S6 pins are for transmitting data of the first storage. S8˜S14 pins are employed by the second storage, and S9, S10, S12, S13 pins are for transmitting data of the second storage. Besides, P1˜P4 are regarded as control pins.

Continuity, P4 pin in P1˜P4 pins is regard as a detection pin for determining that S2, S3, S5, S6 data pins and S9, S10, S12, S13 data pins adopt what kind of transfer protocol to transmit data. For example, when the signal state of P4 pin as zero (or lower potential) is detected, it will be determining that the two storages transmit data conforming to PCIe transfer protocol specification by the using of S2, S3, S5, S6 data pins and S9, S10, S12, S13 data pins; otherwise, when the signal state of P4 pin as one (or higher potential) is detected, it will be determining that the two storages transmit data conforming to SATA transfer protocol specification by the using of S2, S3, S5, S6 data pins and S9, S10, S12, S13 data pins. Thereby, the specified transfer protocol of the two storages could be known by detecting the signal state of P4 pin.

In the past, the conventional SATA Express interface storage device configured with two storages, whose data transfer protocols must be specified as the same, due to only adopt single detection pin (such as P4 pin) to determine the data transfer protocols of the two storages. For example, the data transfer protocols of the two storages are both specified as SATA transfer protocols or PCIe transfer protocols. If the conventional SATA Express interface storage device is used to transmit two transfer protocols of data and further applied in a conventional motherboard, in which it will make the conventional motherboard unable to determine two transfer protocols type of data and thus causing the operation of the motherboard stopped.

### SUMMARY

It is one object of the present invention to provide a storage device, in which having a connector conforming to SATA Express interface specification and being configured with two storages. The SATA Express interface connector is able to respectively access the data of the two storages in the same transfer protocol or the differential transfer protocol.

It is one object of the present invention to provide a storage device and motherboard insertedly provided thereof, wherein the storage device comprises a connector conforming to SATA Express interface specification and being configured with two storages, and the motherboard comprises a connecting seat conforming to SATA Express interface specification. Two detection pins are defined from pins of the connector and the connecting seat, respectively. When the two detection pins of the connector are electrically contacted with the two detection pins of the connecting seat, such that will generate two detection signals, in which a microprocessor of the connecting seat, by detecting the two detection signals, is able to determine the data for one or two transfer protocol types, which are accessed from the two storages of the storage device.

To achieve above objects, the present invention provides a storage device with SATA express interface, comprising: a connector, conforming to SATA Express interface specification, comprising a first data connecting terminal, a second data connecting terminal and a control terminal, wherein said first data connecting terminal, said second data connecting terminal and said control terminal are having a plurality of connector pins, respectively, wherein two detection pins of the connector are defined from the connector pins of the control terminal; a first controller unit, connected to the first data connecting terminal and a first storage for storing data, defining the first data connecting terminal to transmit the data of the first storage in a first transfer protocol specification or a second transfer protocol specification; and a second controller unit, connected to the second data connecting terminal and a second storage for storing data, defining the second data connecting terminal to transmit the data of the second storage in the first transfer protocol specification or the second transfer protocol specification, in which there is able to determine that the first data connecting terminal or the second data connecting terminal for transmitting data conforming to the first transfer protocol specification or the second transfer protocol specification by detecting the two detection pins of the connector.

In one embodiment of the present invention, wherein the first data connecting terminal and the second data connecting terminal are used to transmit the data in the same transfer protocol specification or the different transfer protocol specification.

In one embodiment of the present invention, wherein the connector is formed as a gold finger of connector or a pin type of connector.

The present invention further provides a motherboard insertedly provided for the storage device, comprising: a microprocessor; and a connecting seat, conforming to SATA Express interface specification, connected to the microprocessor, comprising a first data connecting port, a second connecting port and a control port, wherein the first data connecting port, the second data connecting port and the control port are having a plurality of connecting seat pins, respectively, wherein two detection pins of the connecting seat are defined from the connecting seat pins of the control port, when the first data connecting terminal, the second data connecting terminal and the control terminal of the connector are inserted into the first data connecting port, the second data connecting port and the control port of the connecting seat, the two detection pins of the connector will be electrically contact with the two detection pins of the connecting seat so as to generate two detection signals, in which the microprocessor is able to determine that the first data connecting port or the second data connecting port for transmitting data conforming to the first transfer protocol specification or the second transfer protocol specification by detecting the two detection signals.

In one embodiment of the present invention, wherein the first data connecting port and the second data connecting port are used to transmit the data in the same transfer protocol specification or the different transfer protocol specification.

In one embodiment of the present invention, wherein the first transfer protocol specification is SATA transfer protocol specification, and the second transfer protocol specification is PCIe transfer protocol specification.

In one embodiment of the present invention, wherein the connecting seat is formed as a gold finger of connecting seat or a pin type of connecting seat.

### BRIEF DESCRIPTION OF THE DRAWINGS

The structure as well as preferred modes of use, further objects, and advantages of this invention will be best understood by referring to the following detailed description of some illustrative embodiments in conjunction with the accompanying drawings, in which:

FIG. 1 is a stereoscopic diagram of a storage device and a motherboard insertedly provided thereof according to one embodiment of the present invention.

FIG. 2 is a circuit diagram of the storage device and the motherboard insertedly provided thereof according to one embodiment of the present invention.

FIG. 3 shows the pin arrangement of the connector and the connecting seat according to the present invention.

### DETAILED DESCRIPTION OF THE PREFERRED EMBODIMENTS

The present invention may be exemplified but not limited by various embodiments as described hereinafter.

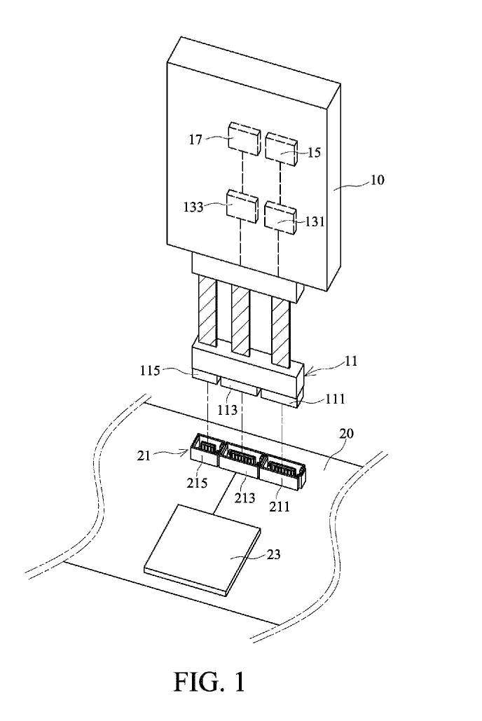

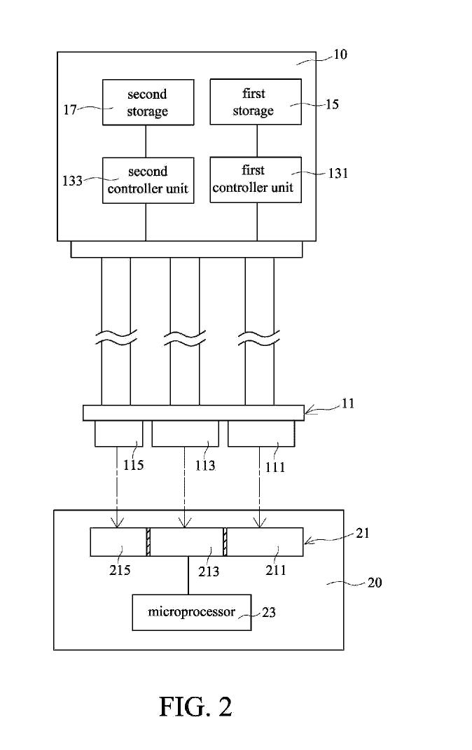

Please refer to FIG. 1 and FIG. 2 for a stereoscopic diagram and a circuit diagram, respectively, of a storage device and a motherboard insertedly provided thereof according to one embodiment of the present invention. As shown in these figures, the storage device 10 comprises a connector 11, a first controller unit 131, a second controller unit 133, a first storage 15 and a second storage 17. The first controller unit 131 and the second controller unit 133 may be separate chip modules or integrated into a chip module. The first storage 15 and the second storage 17 are solid-state drive (SSD) or flash memory module. The connector 11 is formed as a gold finger of connector or a pin type of connector, and comprises a first data connecting terminal 111, a second data connecting terminal 113 and a control terminal 115. Wherein the first data connecting terminal 111, the second data connecting terminal 113 and the control terminal 115 are having a plurality of connector pins, respectively. The first controller unit 131 is electrically connected to the first storage 15 and the first data connecting terminal 111, and the second controller unit 133 is electrically connected to the second storage 17 and the second data connecting terminal 113. The first controller unit 131 defines the first data connecting terminal 111 to transmit the data of the first storage 15 in a first transfer protocol specification or a second transfer protocol specification, and the second controller unit 133 defines the second data connecting terminal 113 to transmit the data of the second storage 17 in the first transfer protocol specification or the second transfer protocol specification. In one embodiment of the present invention, the first transfer protocol specification is SATA transfer protocol specification, and the second transfer protocol specification is PCIe transfer protocol specification. In another embodiment of the present invention, the first transfer protocol specification and the second transfer protocol specification are the same transfer protocol specification, for example, the two transfer protocol specifications are both SATA transfer protocol specification or both PCIe transfer protocol specification.

The motherboard 20 is a motherboard of computer system, comprises a connecting seat 21 and a microprocessor 23. The microprocessor 23 is electrically connected to the connecting seat 21. The connecting seat 21 is formed as a gold finger of connecting seat or a pin type of connecting seat. The connecting seat 21 comprises a first data connecting port 211, a second data connecting port 213 and a control port 215. Wherein the first data connecting port 211, the second data connecting port 213 and the control port 215 are having a plurality of connecting seat pins, respectively. The storage device 10 and the motherboard 20 communicate through the connector 11 inserting into the connecting seat 21 so as to transmit data. In one embodiment of the present invention, the storage device 10 directly adopts the connector 11 to insert into the connecting seat 21 of the motherboard 20. In another embodiment of the present invention, otherwise, the storage device 10 can be adopted the connector 11 having a connection cable to insert into the connecting seat 21 of the motherboard 20.

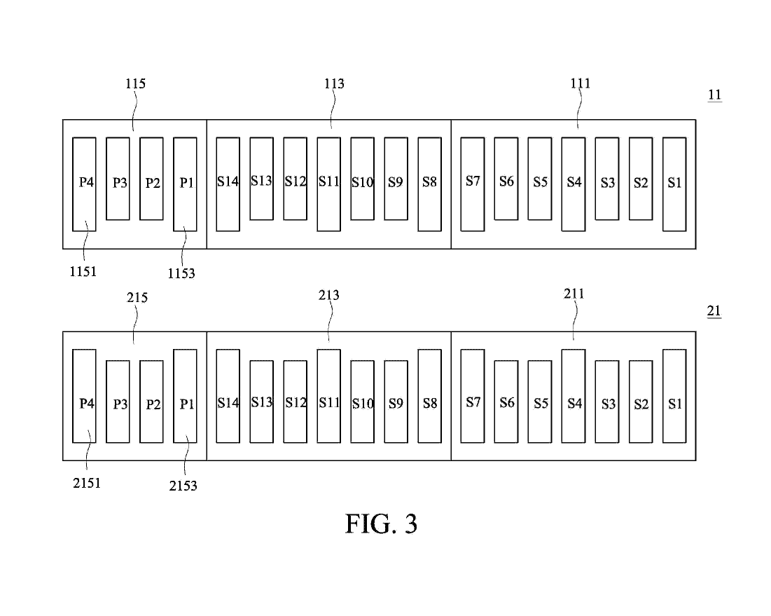

Further refer to FIG. 3, for the pin arrangement of the connector and the connecting seat according to the present invention. The connector 11 and the connecting seat 21 are a connector and a connecting seat conforming to SATA Express interface specification established by SATA-IO association. The pin counts of the connector 11 and the connecting seat 21 are both 14. For the pin definition of the connector 11 and the connecting seat 21 as described in table 2.

TABLE 2

| Pin NO. | Description of Pin | Pin NO. | Description of Pin |
|---|---|---|---|
| S1 | GND | S10 | A1− |
| S2 | A0+ | S11 | GND |
| S3 | A0− | S12 | B1+ |
| S4 | GND | S13 | B1− |
| S5 | B0+ | S14 | GND |
| S6 | B0− | P1 | DET2 |
| S7 | GND | P2 | PERST# |
| S8 | GND | P3 | CLKREQ#/DEVSLP |
| S9 | A1+ | P4 | DET1 |

S1˜S7 pins are the pins of the first data connecting terminal 111 and the first data connecting port 211, which are employed by the first storage 15. Wherein S2, S3, S5, S6 pins are defined as the pins for transmitting data of the first storage 15. S8˜S14 pins are the pins of the second data connecting terminal 113 and the second data connecting port 213, which are employed by the second storage 25. Wherein S9, S10, S12, S13 pins are defined as the pins for transmitting data of the second storage 25. P1˜P4 pins are the pins of the control terminal 115 and the control port 215.

In the control terminal 115 and the control port 215 of the present invention, in addition to P4 pin defined as a detection pin 1151, 2151, the original idle P1 pin is also defined as another detection pin 1153/2153. When the storage device 10 is inserted into the connecting seat 21 by means of the connector 11, the first data connecting terminal 111, the second data connecting terminal 113 and the control terminal 115 will be respectively combined with the first data connecting port 211, the second data connecting port 213 and the control port 215 so that the two detection pins 1151, 1153 of the connector 11 are electrically contacted with the two detection pins 2151, 2153 of the connecting seat 21 and therefore generating two detection signals DET1, DET2. The two detection signals DET1, DET2 will reflect the relative electrical state (such as the potential state) according to the first data connecting terminal 111 and the corresponding first data connecting port 211 as well as the second data connecting terminal 113 and the corresponding second data connecting port 213 adopting what kind of transfer protocol to transmit data. Thereafter, the microprocessor 23 is able to determine that the two storages 15, 17 configured in the storage device 10 are defined to adopt what kind of transfer protocol to transmit data, individually, by detecting the electrical state of the two detection signals DET1, DET2.

Table 3 taken as an example, when the microprocessor 23 receives DET1=0 and DET2=0, it will determine that the first connecting terminal 111 and the corresponding first connecting port 211 as well as the second connecting terminal 113 and the corresponding first connecting port 213 are both adopting SATA transfer protocol specification to transmit data. When the microprocessor 23 receives DET1=0, DET2=1, it will determine that the first connecting terminal 111 and the corresponding first connecting port 211 are adopting SATA transfer protocol specification to transmit data, and the second connecting terminal 113 and the corresponding first connecting port 213 are adopting PCIe transfer protocol specification to transmit data. When the microprocessor 23 receives DET1=1, DET2=0, it will determine that the first connecting terminal 111 and the corresponding first connecting port 211 are adopting PCIe transfer protocol specification to transmit data, and the second connecting terminal 113 and the corresponding first connecting port 213 are adopting SATA transfer protocol specification to transmit data. When the microprocessor 23 receives DET1=1, DET2=1, it will determine that the first connecting terminal 111 and the corresponding first connecting port 211 as well as the second connecting terminal 113 and the corresponding first connecting port 213 are both adopting PCIe transfer protocol specification to transmit data.

TABLE 3

DET 1

| DET2 | 0 | 1 |
|---|---|---|
| 0 | SATA + SATA | PCIe + SATA |
| 1 | SATA + PCIe | PCIe + PCIe |

Therefore, the microprocessor 23 of the motherboard 20 of the present invention is able to correctly determine that the first connecting terminal 111 and the corresponding first connecting port 211 as well as the second connecting terminal 113 and the corresponding first connecting port 213 are adopting the same transfer protocol or the different transfer protocol to transmit data, respectively, by detecting the signal state of DET1, DET2. As such, the SATA Express interface of the present invention is capable to select the same transfer protocol specification or the different transfer protocol specification to access the data within the two storages 15, 17.

In the past, two data connecting terminals or two data connecting ports of the conventional SATA interface only used to transmit data in the same transfer protocol specification, for example, two data connecting terminals or two data connecting ports of the conventional SATA interface are both used to transmit data in SATA transfer protocol specification or both used to transmit data in PCIe transfer protocol specification. Oppositely, two data connecting terminals 111, 113 or two data connecting ports 211, 213 of the SATA interface of the present invention are capable to transmit data in the different transfer protocol specification, for example, the first data connecting terminal 111 and the corresponding first data connecting port 211 are used to transmit data in SATA transfer protocol specification, and the second data connecting terminal 113 and the corresponding second data connecting port 213 are used to transmit data in PCIe transfer protocol specification.

In another embodiment of the present invention, the SATA Express interface of the present invention may be select one data connecting terminal and one corresponding data connecting port (such as the first data connecting terminal 111 and the first data connecting port 211) as the data interfaces of a specified storage, and select another data connecting terminal and another corresponding data connecting port (such as the second data connecting terminal 113 and the second data connecting port 213) as the application interfaces of a specified application module (such as a display module, a WIFI wireless communication module). As such, the SATA Express interface of the present invention not only has the function of access the storage data, but also includes other specified application purpose.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. A storage device with SATA express interface, comprising:
a connector, conforming to SATA Express interface specification, comprising a first data connecting terminal, a second data connecting terminal and a control terminal, wherein said first data connecting terminal, said second data connecting terminal and said control terminal are having a plurality of connector pins, respectively, wherein two detection pins of said connector are defined from said connector pins of said control terminal;
a first controller unit, connected to said first data connecting terminal and a first storage for storing data, defining said first data connecting terminal to transmit the data of said first storage in a first transfer protocol specification or a second transfer protocol specification; and
a second controller unit, connected to said second data connecting terminal and a second storage for storing data, defining said second data connecting terminal to transmit the data of said second storage in said first transfer protocol specification or said second transfer protocol specification, in which there is able to determine that said first data connecting terminal or said second data connecting terminal for transmitting data conforming to said first transfer protocol specification or said second transfer protocol specification by detecting said two detection pins of said connector.

2. The storage device according to claim 1, wherein said first data connecting terminal and said second data connecting terminal are used to transmit the data in the same transfer protocol specification or the different transfer protocol specification.

3. The storage device according to claim 1, wherein said first transfer protocol specification is SATA transfer protocol specification, and the second transfer protocol specification is PCIe transfer protocol specification.

4. The storage device according to claim 1, wherein said connector is formed as a gold finger of connector or a pin type of connector.

5. A motherboard, insertedly provided for the storage device according to claim 1, comprising:
a microprocessor; and
a connecting seat, conforming to SATA Express interface specification, connected to said microprocessor, comprising a first data connecting port, a second connecting port and a control port, wherein said first data connecting port, said second data connecting port and said control port are having a plurality of connecting seat pins, respectively, wherein two detection pins of said connecting seat are defined from said connecting seat pins of said control port, when said first data connecting terminal, said second data connecting terminal and said control terminal of said connector are inserted into said first data connecting port, said second data connecting port and said control port of said connecting seat, said two detection pins of said connector will be electrically contact with said two detection pins of said connecting seat so as to generate two detection signals, in which said microprocessor is able to determine that said first data connecting port or said second data connecting port for transmitting data conforming to said first transfer protocol specification or said second transfer protocol specification by detecting said two detection signals.

6. The motherboard according to claim 5, wherein said first data connecting port and said second data connecting port are used to transmit the data in the same transfer protocol specification or the different transfer protocol specification.

7. The motherboard according to claim 5, wherein said first transfer protocol specification is SATA transfer protocol specification, and the second transfer protocol specification is PCIe transfer protocol specification.

8. The motherboard according to claim 5, wherein said connecting seat is formed as a gold finger of connecting seat or a pin type of connecting seat.
